(19) United States
(12) Patent Application Publication
(10) Pub. No.: US 2014/0201705 A1
(43) Pub. Date: Jul. 17, 2014

(54) EXTENDED FRAMEWORK FOR NO-CODING DYNAMIC CONTROL WORKFLOW DEVELOPMENT ON SPATIAL ENTERPRISE SYSTEM

(71) Applicant: Xuewei Ren, Sandy Springs, GA (US)

(72) Inventor: Xuewei Ren, Sandy Springs, GA (US)

(21) Appl. No.: 13/740,184

(22) Filed: Jan. 12, 2013

(51) Int. Cl. G06F 9/44

(52) U.S. Cl. CPC G06F 8/20
USPC 717/102

(57) ABSTRACT

Disclosed is the extended framework which enables the business analysts to develop the enterprise solutions at the runtime without coding. The workflow framework has been developed on Spatial Enterprise System (SES). To develop this framework, the role model and the workflow model have been developed first to address the basic concepts involved in the development of the enterprise solutions. With the concepts clearly defined, the components and the data structures have been developed. Furthermore, the processing engine (DC engine) has been developed to process these components and data structures at the runtime.

The workflow framework consists of the implementation of the workflow, the stages and the dynamic controls. The workflow is the business logic through which the business tasks can be achieved. The stage is the small business task inside the workflow. The dynamic control is the controls which can interact with user to modify the business entities to complete the task. Combining with the existing models of SES, the workflow framework has achieved the no-coding dynamic control (NCDC) goal of the enterprise solution development.

### BACKGROUND OF THE INVENTION

In enterprise organizations, the business workflows are being developed by the IT developers. The developers usually acquire the requirements from the business analysts and develop the solutions based upon these requirements. This procedure has many problems.

One, since the developers don't have the deep understanding of the business, it's questionable how well they can understand the requirements provided by the business analysts. Without the good understanding of the requirements, the delivery of the quality solutions is questionable. There are the statistic data that show that the most enterprise projects have failed.

Two, the requirements provided by the analysts only indicate the best knowledge of the analysts at the time of writing. It is not unusual that the differences exist between what the analysts have known and what the businesses really need. These differences often make the solutions less useful after the solutions have been delivered.

Three, the enterprise businesses are evolving. With the new technologies rolling into the market rapidly, this evolution is now faster than ever before. Due to the fast evolution, the solutions often become obsolete even before they are delivered. The projects must be either aborted or switched to other projects. It is the waste of the investment.

Four, even if the development of the solution can go through all the obstacles and finally be delivered to the end users, the code quality may not be good and the architecture of the solution may not be strong. There are two facts could cause this. One, forcing the developers focusing on the current business situations leaves them no room for the forward thinking. Two, the goals to solve the business problems shift the developers' focus point away from the code quality and the long-lasting architecture. As observed on many systems, the architectures with the fatal flaws are very common for the enterprise systems. With such architectures, the long-lasting solutions are not possible. It is not unusual that the major architecture refactoring occurs every 2-3 years in the enterprise systems. And the more solutions have been built on the system, the harder the refactoring job will be.

Overall, as the conclusion of the above discussions, the development of the enterprise solutions is often expansive and risky. The industries and organizations are looking and waiting for the new technologies to solve these problems. The present invention, the extended framework for the no-coding dynamic control (NCDC) workflow development, is invented to solve these problems.

### SUMMARY OF THE INVENTION

The present invention provides the extended software framework on Spatial Enterprise System (SES) to achieve the concept of no-coding workflow development for the enterprise solutions, which allows the business analysts to develop the business workflows without writing any code. Achieving this concept can dramatically reduce the cost and risks for the development of the enterprise solutions.

The present invention developed a role model that defines the roles for the enterprise solutions. In this role model, the business analysts are the roles to develop the business solutions. The developers assist the business analysts by providing the prepackaged dynamic controls (DC). The business analysts use these controls to build the enterprise solutions. The end user executes the solutions that have been developed by the business analysts. The business analysts will be able to write the solutions just like writing the office documents.

The present invention defined and implemented a workflow model on Spatial Enterprise System (SES), which allows the business analysts to model the enterprise solutions at runtime. This workflow model is the addition to the existing models on SES. Combined with other existing models on SES such as the data source model, the feature data model, the layer model and the user model, the workflow model enables the business analysts develop the solutions and push them to the end user seamlessly at runtime.

The key concept of the workflow model is the workflow. In this work flow model, one enterprise solution comprises multiple workflows and one workflow comprises multiple stages. The end user executes the workflow by completing the tasks on each stage. The present invention has developed the technologies that are necessary and sufficient to process this procedure.

The dynamic control concept has been defined, designed and implemented, which allows the users to do the data operations. These data operations include the operations of adding, removing, modifying and querying the data from the data source. The developers are responsible to develop the dynamic controls. The business analysts create the enterprise solutions by drawing and configuring the dynamic controls for each stage of the workflow.

The present invention has implemented a set of prebuilt dynamic controls on SES. These dynamic controls enable the business analysts to write the solutions easily. In addition to these prebuilt controls, the present invention has also developed the dynamic control SDK for the developers to develop the custom dynamic controls. The developers can package the custom dynamic controls to target the specific problem domains.

The dynamic controls are created at runtime. This requires a runtime engine to process the dynamic controls. The present invention has also developed the dynamic control (DC) engine for the mobile, desktop and web platforms. With this engine, the dynamic controls can be deployed to the varieties of the platforms as long as these controls have been configured and saved to the server.

### BRIEF DESCRIPTION OF THE DRAWINGS

The present invention and the following detailed description of certain embodiments thereof may be understood by reference to the following figures:

FIG. 1 shows the role model, which defines the roles and their responsibilities involved in the enterprise solutions in general.

FIG. 2 shows the flowchart for the hotel reservation workflow to illustrate the multiple steps and stages in the workflow.

FIG. 3 shows the component diagram to illustrate the basic components of the workflow framework.

FIG. 4 shows the workflow property dialog box to illustrate how the workflow and stages are created and configured at the GUI level.

FIG. 5 shows the Admin console GUI layout of SES to illustrate how the workflow model and its components work together with existing models and data viewer.

FIG. 6 shows the GUI portion of the user configuration on SES to illustrate how to configure the user.

FIG. 7 shows the GUI portion on SES to illustrate how to assign the workflow to the user.

FIG. 8 shows the GUI layout of web client to illustrate how the workflow and the dynamic controls work on the browser-based platform.

FIG. 9 shows the GUI layout of mobile client to illustrate how the workflow and the dynamic controls work on the mobile platform.

FIG. 10 shows the class diagram to illustrate the components and the dynamic controls that have been defined and developed in the present invention.

FIG. 11 shows the class diagram to illustrate how to develop the dynamic controls. The dynamic control used for this example is the IndexTable control, which has been packed in the workflow framework.

FIG. 12 shows the GUI layout of how the dynamic control works on Admin console of SES. This dynamic control shown here is the same control that has been designed and implemented in FIG. 11.

FIG. 13 shows the dialog boxes how to configure the dynamic control on Admin console of SES. This dynamic control shown here is the same control that has been designed and implemented in FIG. 11.

FIG. 14 shows the class diagram to illustrate the basic components of the DC engine, which is the engine to create and process the dynamic controls at the runtime on multiple platforms.

FIG. 15 shows a sequential diagram to illustrate how the components of the DC engine work together to handle the requests from the user related the processing tasks for the dynamic controls.

### DETAIL DESCRIPTION

The procedure currently used for developing the enterprise solutions have been proven costly and risky. The enterprise organizations have been struggling to solve the problems related to this. The direct attempt is to change the procedures. Many organizations are trying to adopt some kind of agile procedure, which splits the big task into multiple small tasks. The progress of these small tasks can clearly be monitored. If anything goes wrong with these small tasks, the project can be corrected or even aborted without big damage. But the question is—how to know the tasks have gone wrong? The small tasks are usually taken much early before the entire solution can be finished. At the early stage, it is very hard to come up with a big picture to tell what have gone wrong towards the entire solution. And, at the late stage, the investment has already been spent and the damages have already been made.

It is believed that solving this problem requires the procedure change. But, the procedure change requires the technologies to support the change. Only changing the procedure will just shuffle the problem around, which won't really solve the problem. The agile procedure requires the technology to identify how the small tasks contribute to the big solution. Without this technology, the agile will face the save problem as the traditional procedure. But, with this technology available, no agile procedure is necessary. If the technology can identify what could go wrong before the project starts, the development of the project will be corrected without the agile procedure. Developing such a technology is one of the goals of the present invention.

The present invention provides the technology to support NCDC (No-Coding Dynamic Control) procedure of the workflow development. In NCDC procedure, the enterprise solutions are not created by coding, they are created by modeling. The dynamic controls are basic components for this modeling procedure. The business analysts model the enterprise solutions by dragging and dropping the dynamic controls (DC) into the layer editing panel. With these DCs created and configured, the business analysts can execute the workflows of the solutions instantaneously. If anything goes wrong, they can instantaneously correct it by changing the behaviors of the dynamic controls. As soon as the modeling procedure has been completed, the solution can be directly pushed to the users to join the daily business operations of the organization.

As described above, the NCDC procedure must be achieved based on the new role model. This role model requires that the business solutions must be developed by the business analysts. This new role model is called the NCDC role model. In addition to the requirement mention before, the NCDC role model also provides other role requirements. The NCDC role model defines the rules for the roles involved in the workflow development of the enterprise solutions. The following are the key concepts of the NCDC role model:
a) There are three user roles involved in the NCDC role model—the end users, the business analysts and the developers. The developers implement the dynamic controls. The business analysts implement the business workflows. And the end users execute the workflows.
b) The developers implement the dynamic controls by utilizing the dynamic control SDK (Software Development Kits).
c) The business analysts implement the workflows by utilizing the pre-built dynamic controls. This procedure should not have any coding involved.
d) The end users execute the workflows by completing the data operations by utilizing the configured dynamic controls.

The NCDC role model is different from the model used for the current development of the enterprise solutions. In the current model, the developers implement the solutions. The business analysts only give the developers the requirements and the feedbacks about the solutions. In NCDC role model, the developers don't develop the solutions. They only develop the tools—the dynamic controls. The business analysts use these tools to develop the solutions. The NCDC role model has many advantages versus the traditional role model for the enterprise solution development.

First, the developers don't have to gain any domain knowledge. Domain knowledge is precious and learning it requires many years of the experience. Forcing the developers gaining the domain knowledge is not only impossible, but also unnecessary. But, the existing model is actually doing that—letting the developers implement the solutions implicitly forces the developers to gain the domain knowledge. The domain knowledge is the expert knowledge and should only be left for the experts.

Second, because the business model has been taken away from the developers' focus point, the developers can focus on the programming model. This makes it possible for the developers to create the clean and solid architectures. And eventually, it makes it possible to build the low-maintenance, high-quality and long-lasting systems.

Third, the business analysts create the solutions instantaneously. They can try the solutions over and over until they are satisfied. This guarantees the quality of the solutions and tremendously reduces the cost and risk of the solution development.

Fourth, the solution improvement can be made easy and fast. The solutions must evolve as the business evolves. In the NCDC role model, to catch this evolution trend, the business analysts can just make the changes on the solutions and push them to the users at GUI level without any coding involved.

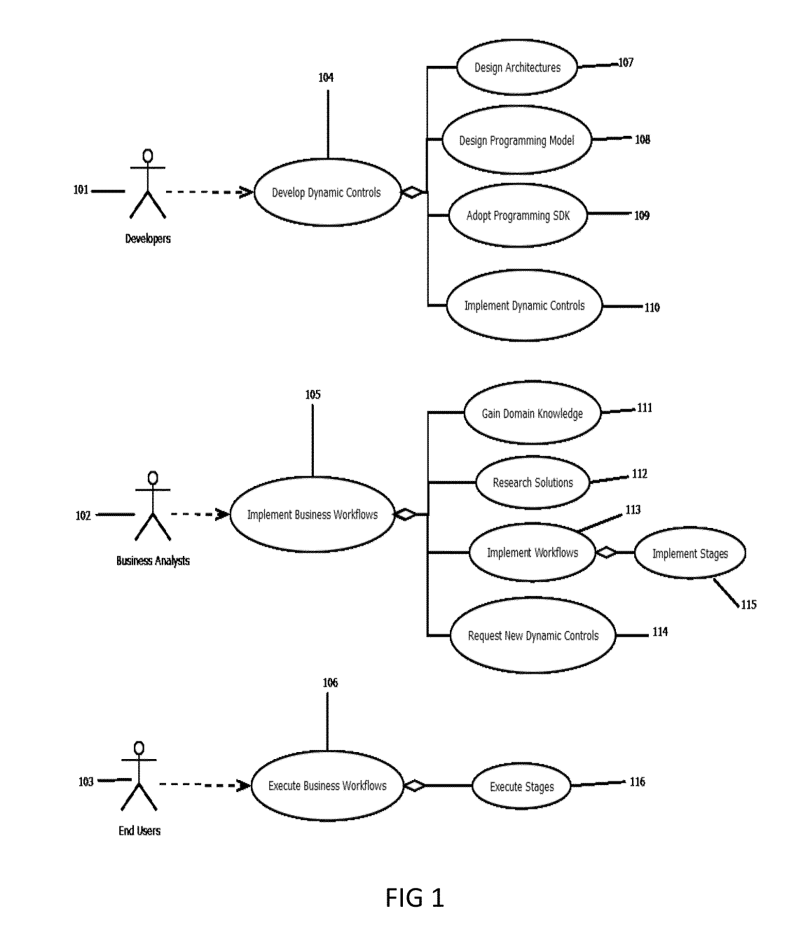

FIG. 1 utilizes the UML use case diagram to illustrate the NCDC role models. As indicated in the diagram, the developer (101) only need to developer the dynamic controls (104), which includes designing architectures (107), designing programming models (108), adopting programming SDK (109) and implementing dynamic controls (110). The developer's duties should never involve the development of business solutions. The business analyst (102) is responsible for the development of business solutions. The business solution is developed by implementing the workflows (105), which includes gaining the domain knowledge (111), researching the solutions (112), implementing the workflows (113) and requesting the new controls (114) from the developers. Since each workflow will include multiple stages, the implementation of workflow (113) will also include the implementation of stages (115) for the business analysts. The workflow model will be described in detail later in this document. The end user (103) executes the workflows (106) implemented by business analyst. Again, executing workflow will also include executing the stages (116) within the workflow.

While the NCDC role model clearly defines the roles for the enterprise system, the technology must be provided for these roles to handle their jobs seamlessly. In the present invention, this technology has been developed as the NCDC workflow model. The NCDC workflow model defines and implements the concepts that are necessary and sufficient to support the roles defined in the NCDC role model.

The key concept for the NCDC workflow model is the concept of workflow. Workflow is the procedure which consists of multiple steps through which the end user can complete the particular set of tasks to solve the enterprise problems. In computer world, each of these steps is associated with the data operations. In the other words, the goals of each step are actually achieved by the operations for the data structures (enterprise entities). Hence, the concept of stage has been introduced for the workflow. Stage is the state of the data that each step of the workflow tries to achieve as the goal. In the NCDC workflow model, the operations executed on the dynamic controls in each step will eventually make the data to reach the desired stage.

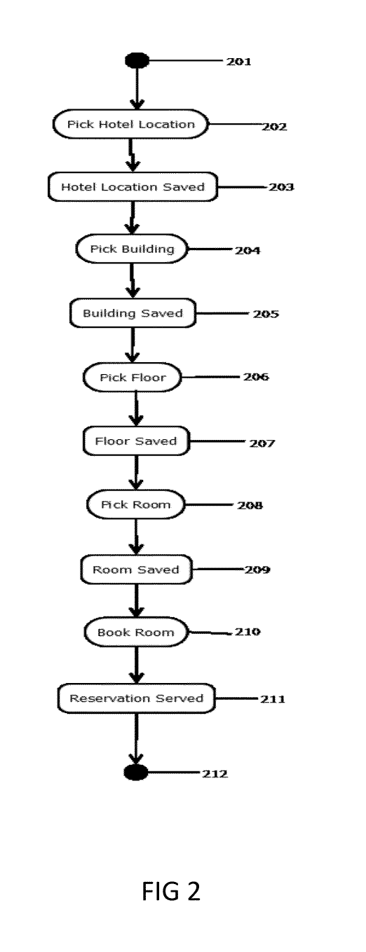

FIG. 2 shows an example workflow to illustrate the concepts of the NCDC workflow model. This is a workflow for the hotel-reservation transaction. The start (201) and end (212) nodes indicate the start and end states of the workflow. This workflow includes five steps—pick location (202), pick building (204), pick floor (206), pick room (208) and book the room (210). For each step, the five data stage must be achieved—location picked (203), building picked (205), floor picked (207), room picked (209) and reservation served (211). Only finishing all stages means the workflow has completed.

The workflow shown in FIG. 2 appears to be simple. But, to achieve it seamlessly is not simple. There is no programming architecture and framework that can support it currently. This is the motivation of the present invention, which is to develop a programming architecture and framework to support the no-coding seamless workflow development. This programming architecture and framework are encapsulated into the NCDC workflow model, which is the programming model to support the no-coding seamless workflow development.

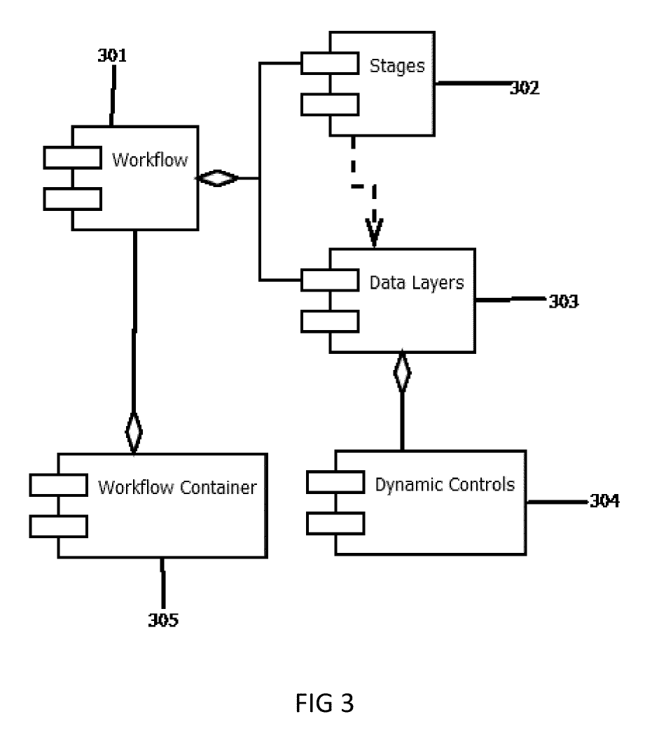

FIG. 3 shows the key components of the NCDC workflow model. As indicated in FIG. 3, the workflow (301) consists of multiple stages (302) and multiple data layers (303). The stage contains the rules and defines the goals that the data has to achieve through the operations on the DCs. The data layers define the candidate layers of the data that will participate for the particular stage to reach the goal. The data layers contain the dynamic controls (304), which are the controls the end user will use to process the data operations. Overall, the multiple workflows will be packed in the workflow container (305) so that they can be directly pushed to the end users. As the result, the end users will be able to access multiple workflows simultaneously through the workflow container.

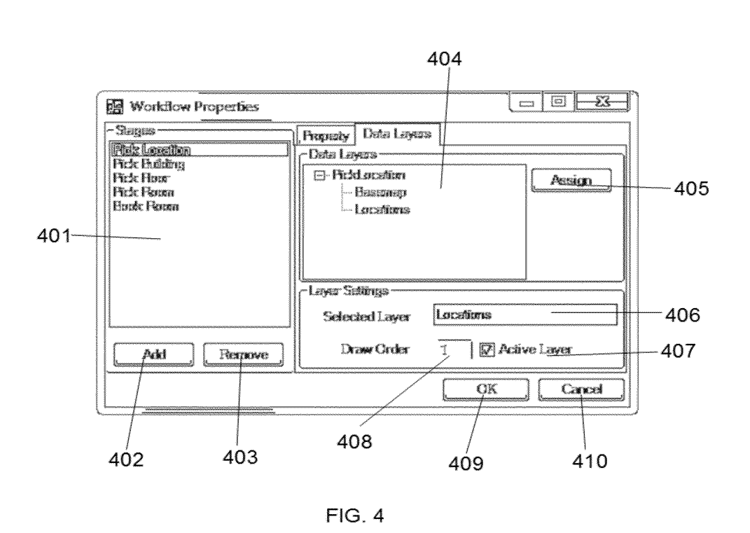

FIG. 4 shows the dialog box for the workflow configuration, which has been developed on SES (Spatial Enterprise System, patent application Ser. No. 13/045,512). The list box (401) stores the stage data. The two buttons—Add (402) and Remove (403) allows user to add and remove the stage for this workflow. The tree box (404) stores the data layers that should be previously configured. The assign button (405) allows user to assign a group of data layers to this stage. The user can select the data layer in the tree box (404). The name of the selected layer will be display in the text box (406). For the selected layer, user can set the draw order through the text box (408) and set the active layer property through the check box (407). The two other button—OK (409) and Cancel (410) are the button to commit or rollback the changes.

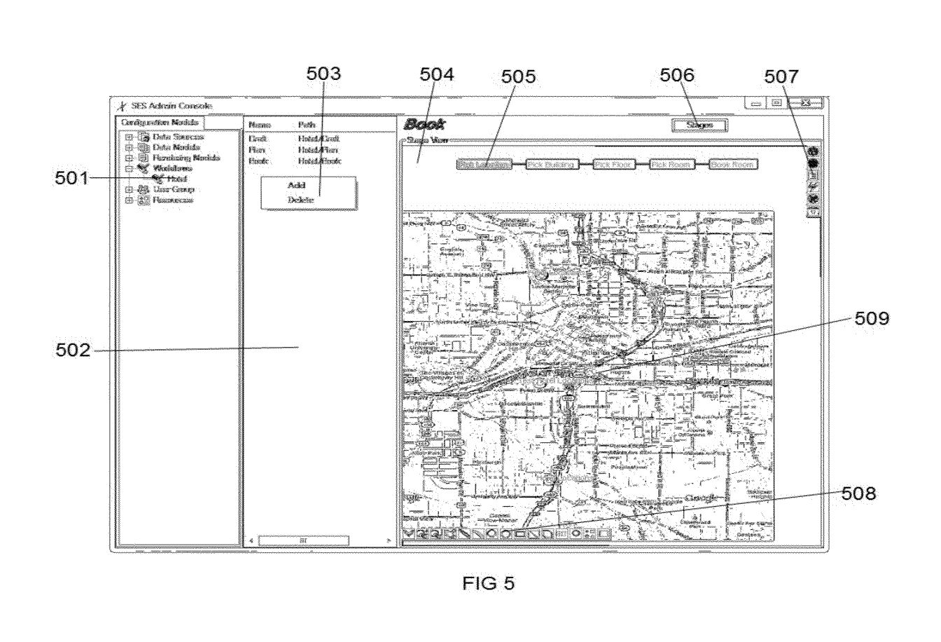

The functions of adding and removing workflow to the system have been implemented as the basic configuration procedure in SES. FIG. 5 shows the implementation of how to add and remove workflows into SES. In the master configuration tree box, there is a node named Workflow (501), which allows user to add or remove the group of workflows by using the popup menu (not shown in figure). The concrete workflow can be added in the list box (502) through the popup menu (503). After selecting the workflow in the list box (503), clicking the Stages button (506) will pop up the dialog box as shown in FIG. 4 to allow user to configure the properties of the workflow. The Workflow control (505) is the dynamic control (505) that has been created by the system (DC engine precisely), which allows user to switch the stages within the workflow. The data layers associated with the selected stage are displayed in the view control (509). The drawing and navigation tools (508) allow user to zoom to the particular section of the view and edit the data. And the control tools (507) allow user to add, remove or modify the dynamic controls.

In any enterprise system, the users must be managed. User access management is crucial in the enterprise systems. Depending on the scope of the enterprise system, the roles of these users can be very different. In the NCDC role model, for the perspective of the workflow development, there are three types of roles—developer, business analysts and end user. The particular user must only have the access right to the particular set of data and the operations. The NCDC workflow model achieves this by allowing the system administrators to assign the different workflows to different users.

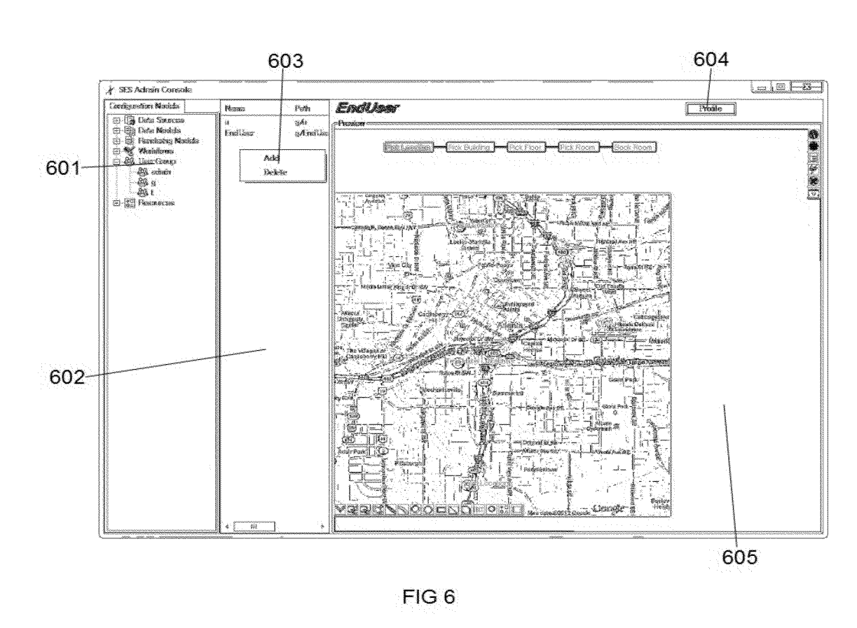

The implementation of workflow assignment has been extended from the existing user assess model on SES. FIG. 6 shows the GUI layout of the existing user access model on SES. In the master configuration tree box, there is a node named User Group (601). The user groups can be added, deleted or modified by using the popup menu of this node. The individual users are displayed in the list box (602). The popup menu (603) can be used to add and remove the users on this list box (602). After the user has been selected, clicking the profile button (604) will pop up a dialog box that allows the administrators to change the property of the selected user. The data layers can be configured in the profile dialog box. The business entities in these data layers are displayed in the view control (605). The functions of assigning the workflow to the user are the part of the configuration of the user profile, which are handled in the popup dialog box by clicking profile button (604).

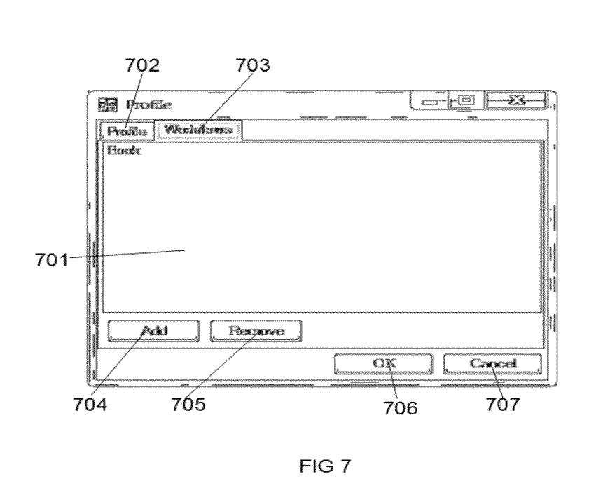

The functions of the workflow assignment have been implemented on SES. FIG. 7 shows the workflow portion of the GUI layout of the user profile dialog box, which illustrates how the workflows are assigned to the selected user. The list box (701) displays the workflows that have been assigned to the user. The tabs, Profiles (702) and Workflows (703) allows user to switch between the general user properties and workflow properties. Add (704) and Remove (705) button allows user to add and remove the workflows assigned to the user. OK (706) and Cancel (707) buttons allows user to save or cancel the changes made to the selected user properties.

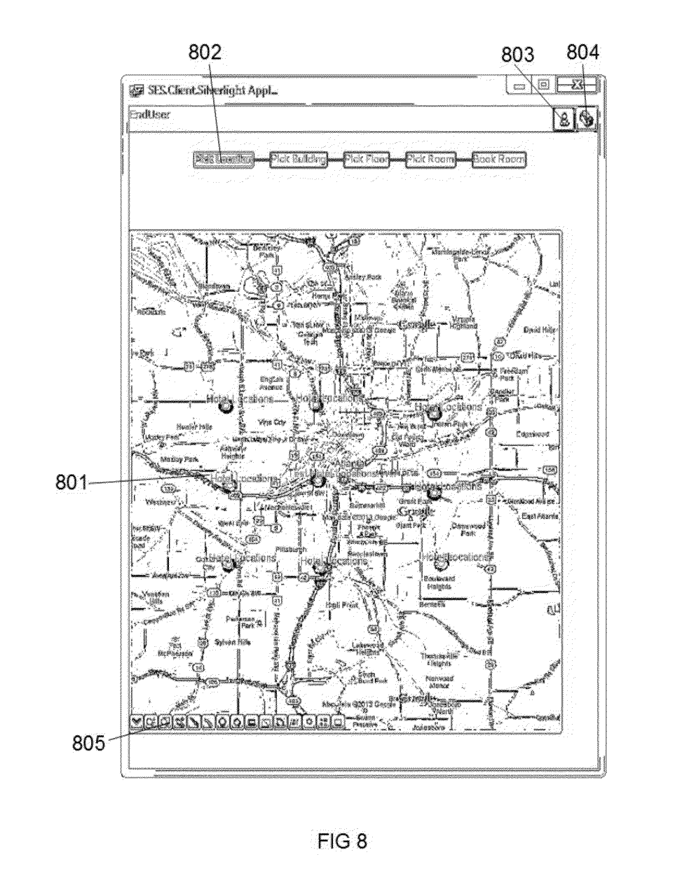

After the workflows have been assigned to the user, the user can execute the workflows by logging into the system using the client platforms. FIG. 8 shows the desktop client view after the user has logged into the system and the data has been retrieved for the configured user. The workflow has been configured and assigned to this user. The view control (801) displays the spatial data that is accessible by this user. The workflow control (802) enables the user to switch the stages within the workflow. Profile button (803) enables the user to do the minimum configuration for the user profile such as changing the user name and password. Logout button (804) enables the user to logout from the system and completes the session. The navigation and drawing toolbar (805) enables the user to navigate the data view and make the change to the spatial data.

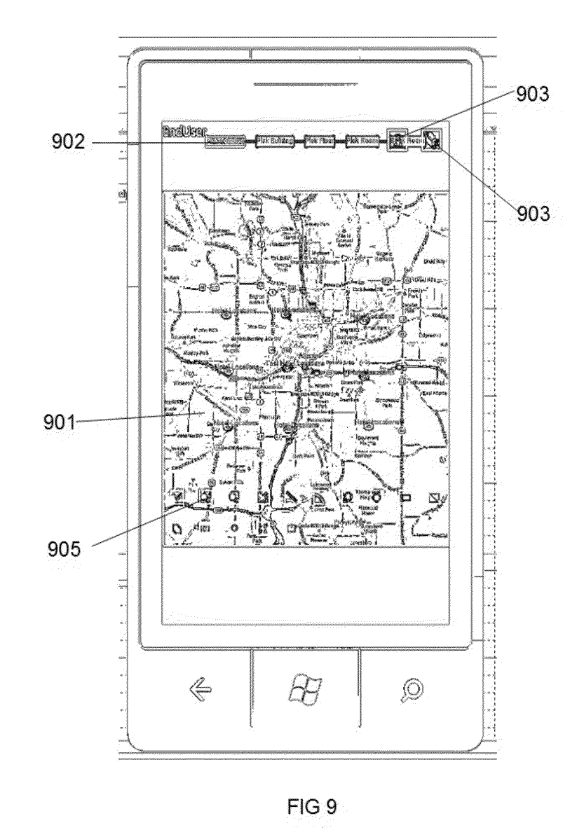

Similar to FIG. 8, FIG. 9 is the mobile view for the same user after having logged into the system. The view control (901) is the control to display data. The workflow control (902) is the dynamic control for user to switch the stages within the workflow. Profile button (903) configures the profiles of the user and Logout button (904) logouts the user. The toolbar (905) provides the tools to navigate and edit the data.

Both FIG. 8 and FIG. 9 showed the common control—the workflow control (802, 902). The workflow control is a dynamic control. The dynamic controls (DC) are the controls that are generated dynamically by the DC engine to represent the displaying business entities and also react to the user's input based on the predefined metadata. The dynamic control is the key concept in the workflow model which has the following characteristics:
1. The dynamic control is dynamic, which means it's generated dynamically by the DC engine based on the predefined metadata. The developers create the DC engine and the business analysts define the metadata for the dynamic control.
2. The dynamic control is another representation of the business entities. In SES, the business entities have one default representation—represented in geometric shape in view control. The dynamic control is the representation of business entities in other forms such as table or chart.
3. The dynamic control is the interface between the user and the business entities. The user is able to enter the input to the system through the dynamic control and get the reactions back from the business entities.
4. The dynamic control is the action handler for the user's requests. When user makes the requests, the dynamic control is able to pass the requests to the DC engine. And, the processing results will be displayed on the dynamic control.

As defined in NCDC role model, the dynamic controls are implemented by the developers by utilizing the DC SDKs packed in SES. A set of SDKs has been developed for the developers to implement the dynamic controls for the supported platforms, which include the mobile, web and desktop platforms. The architecture for DC engine is open so that the developers can extend the existing implementations.

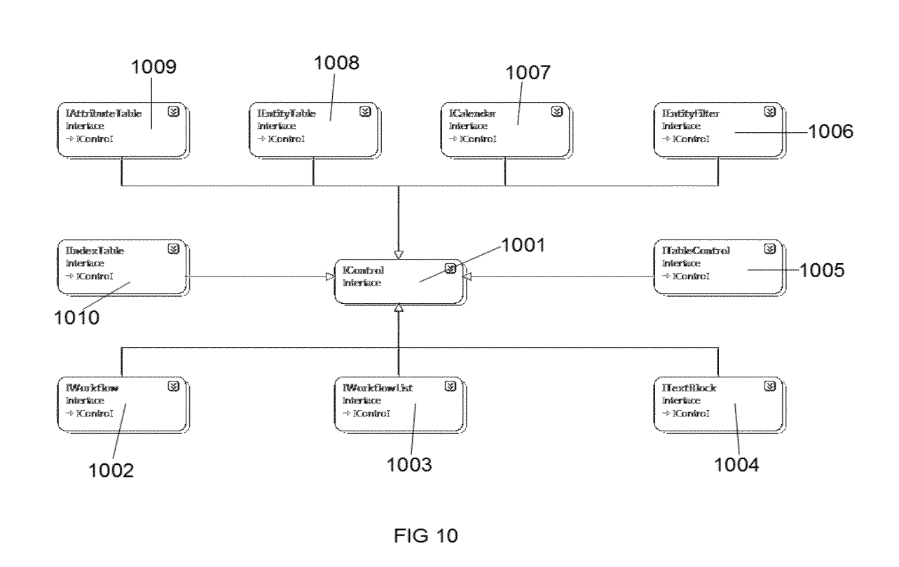

FIG. 10 shows the interfaces of current implementation for the DC framework. IControl interface (1001) is the base interface for all the dynamic controls. It defines the general properties that all other controls must inherit. There is an implementation of IControl in the framework that provides the default implementations of these properties. To write the more specific controls, the developers can just extend the existing implementations and override the properties that are needed to specialize.

Depending on the industrial domain, many DCs will need to be developed to support the different solutions. As the development of DCs can never be depleted, the DC framework of the present invention only provides the basic and crucial implementations of DCs. The following are the brief descriptions of the interfaces of the DCs that have been packed in the DC framework (as shown in FIG. 10):
IWorkflow interface (1002) defines the behavior of the workflow control. The workflow control is the control that allows the user to switch the stages within the workflow.

IWorkflowList interface (1003) defines the behavior of the workflow list control. The workflow list control is the container control that holds the multiple workflows so that the user can access the multiple workflows.

ITextBlock interface (1004) defines the behavior of the text block control. The text block control is the control to display the texts. These texts can be predefined by the business analysts or dynamically generated based on the attributes of the displaying business entities.

ITableControl interface (1005) defines the behavior of the table control. The table control is the control that put the displaying business entities in the tabular form. The table control can be used for the varieties of purposes such as displaying the entity attributes, grouping the attributes of the displaying business entities. ITableControl defines the base behaviors of other more specific table-related controls.

IEntityFilter interface (1006) defines the behavior of the entity filter control. The entity filter control is the control that user can filter the entities based on the predefined categories.

ICalendar interface (1007) defines the behavior of the calendar control. The calendar control is the control to specialize or filter the entities to a specific date.

IEntityTable interface (1008) defines the behavior of the entity table control. The entity table control is the control that displays the attributes of multiple entities in a table format.

IAttributeTable interface (1009) defines the behavior of the attribute table control. The attribute table control is the control to display the attributes of single entity in a table.

IIndexTable interface (1010) defines the behavior of the index table control. Like the index of the document, the index table control is the control that lists the predefined indices so that the user can directly jump to the entities for the selected indices.

The above are just the prebuilt dynamic controls that are packed in SES. The developers can build other dynamic controls for the special purpose. Using DC SDK on SES, the development of the dynamic controls will be conducted in the following steps:
1. Define the behavior of the control in an interface, just like the above definitions of the prebuilt controls.
2. Implement the defined interface. There is a key attribute in IControl interface—displaying entities. The implementation of the define interface is just implementing how to represent the displaying entities in different forms, either in table or chart. The displaying entities should be known as long as the custom DC extends the Control class which implements IControl interface.
3. Design a command and a dialog box to allow the business analyst to configure the DC. The DC engine should take over the rest of the job such as generating the DC and pushing it to the end user.

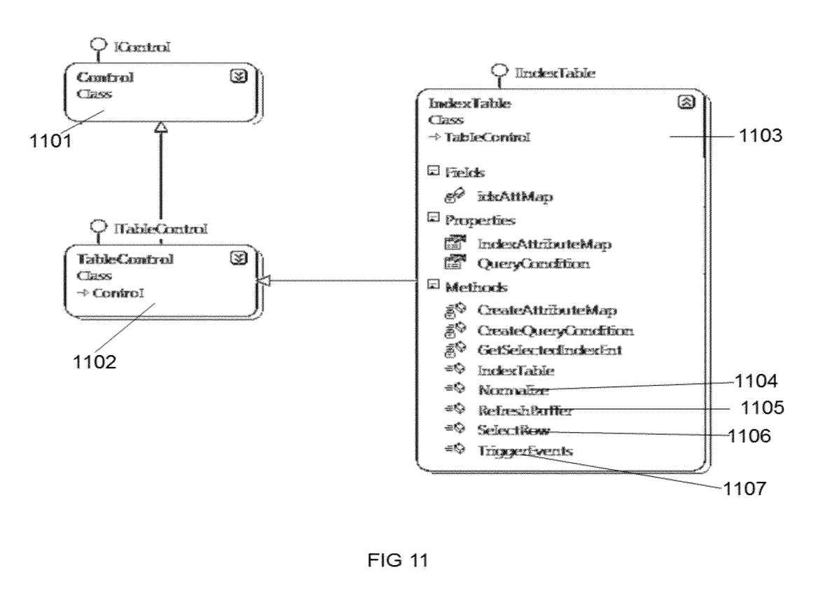

FIG. 11 is the example of the implementation of a dynamic control. IIndexTable has been defined in FIG. 10, which is the interface of the indices of the business entities. In FIG. 11, Control class (1101) implements IControl interface which defines the general properties of all dynamic controls. TableControl class (1102) implements the ITableControl interface and extends the implementation of Control class (1101). This is because IndexTable control also has the properties of the table control. And, finally, IndexTable control (1103) implements IIndexTable interface and extends the implementation of TableControl (1102). Here, for better understanding the implementation, it is worthwhile to mention some of the key methods implemented for the IndexTable control:
Normalize method (1104) is the method to normalize the data. Whenever the new data has been added, the DC engine will call the normalize method of each control to normalize the new data. For IndexTable control, the normalize method will put the selected index value to the predefined attribute field of the newly added data. Normalize is the general method that has been defined in IControl interface.
RefreshBuffer method (1105) is the method to regenerate the displaying entities that represent the business entities. The business entities can be represented in the form of geometric entities as displayed in view control in FIG. 8 and FIG. 9. Or they can be represented in a table control such as EntityTable defined by IEntityTable. The representing entities need to be regenerated dynamically. This method is often called by the DC engine to refresh the displaying entities for the control to cooperate with the changes of the business entities.
SelectRow method (1106) is the method to set selection state of the displaying entities and queue the action events. This is a crucial method defined in ITableControl interface. When user using mouse or tap to select a row of the table control, DC engine will call the implementation of the method. To implement this method, the row must be set high-lighted and the necessary event must be queued.
TriggerEvent method (1107) is the method that DC engine will call to rigger the action event that has been queued from SelectRow methods. Whenever the CPU is idle, one thread of the DC engine will constantly process the queued events until the events in the queue are depleted.

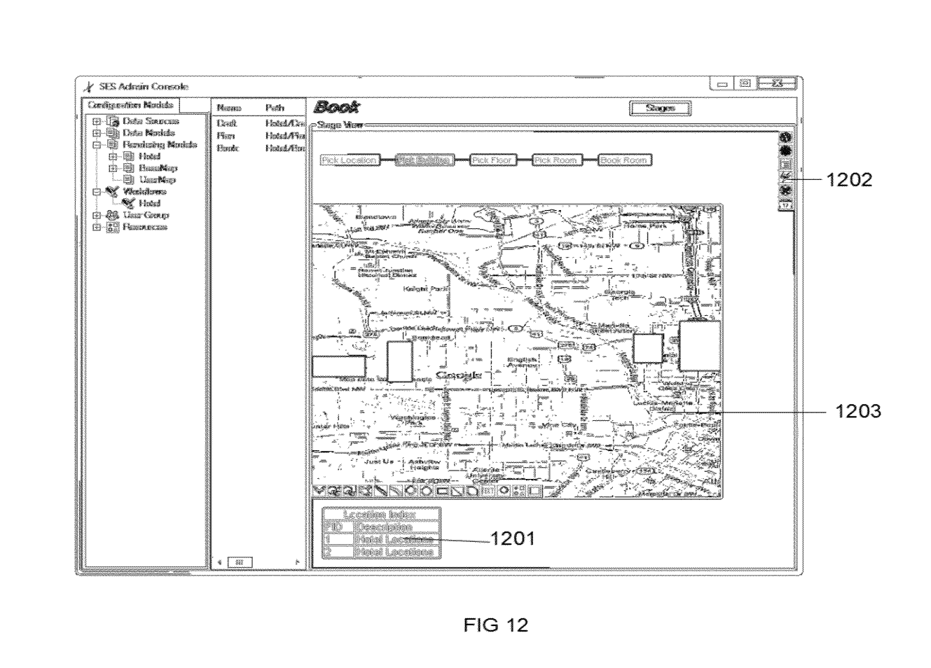

FIG. 12 shows the implemented command on Admin Console after the command has been deployed to SES for the IndexTable implementation. The index table control (1201) has been added to the view screen by DC engine. Selecting the row on this table will enable the business entities linked by the row. It will cause only the index-linked entities shown on the view control (1203). The index table command (1202) has been added to the toolbar. By selecting this command, the business analyst can draw the control on the dedicated area of the screen. After finishing drawing the control, the business analyst can also save the control to the server by selecting the commit command on the popup menu (not shown).

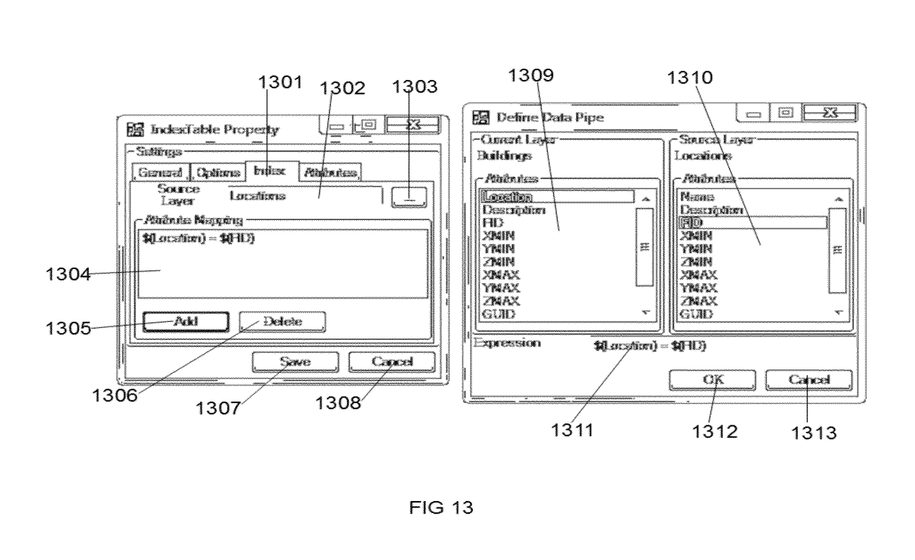

FIG. 13 shows the property dialog box for the IndexTable control. On the left is the property dialog box. Since the IndexTable control is extended from TableControl, it also has the properties of the table control. Here, the descriptions are only focused on configuring the index table properties. Index tab (1301) is the tab to configure the properties of IndexTable control. The only property for index table is the attribute mapping, which maps the entities of current layer to the index layer. There are two parts must be configure for the attribute mapping—selecting the index layer and mapping the attribute fields. The button (1303) is implemented for selecting the index layer. After the button has been clicked, a popup dialog (not shown in FIG. 13) will be shown to allow user to select the layer. The selecting result will be display on the text box (1302). The list box (1304) lists the mappings that have been configured. Add (1305) and Remove (1306) buttons are the buttons to add and remove the attribute mapping from the list box (1304). Save button (1307) saves the configuration to the server and Cancel button (1308) cancels the configuration.

On the right side of FIG. 13 is the dialog box to configure the data pipe (attribute mapping in this case). This dialog box pops up after the Add button (1305) has been pressed. The list box (1309) lists all attribute fields for the current layer and another list box (1310) lists all attribute fields for the index layer. After the attribute fields are selected on both list boxes, the program will automatically create an expression and display on the text box (1311). Clicking OK (1312) will hide the dialog box and the expression will be add to the attribute mapping box (1304). Cancel button (1313) does nothing but closes the dialog.

After the dynamic control has been defined, implemented, deployed and configured, it is the job of the DC (Dynamic Control) engine to process the control at runtime. FIG. 12 shows the necessary classes that handle the processing tasks of the dynamic controls. The drawing panel (1401) is the GUI panel to host the view control (1402). ViewControl (1402) is the component to display the entities in geometric shapes. It is part of the universal framework on SES. ViewControl contains several controller classes that control how the view need to behave based on the loaded entities. Among these controllers, ModelController (1403), MouseController (1404) and ControlController (1405) contributes to the creation and processing of DCs. And ControlController (1405) contains multiple dynamic controls (1406). This is the view portion of the dynamic control, which handles how the dynamic controls are displayed.

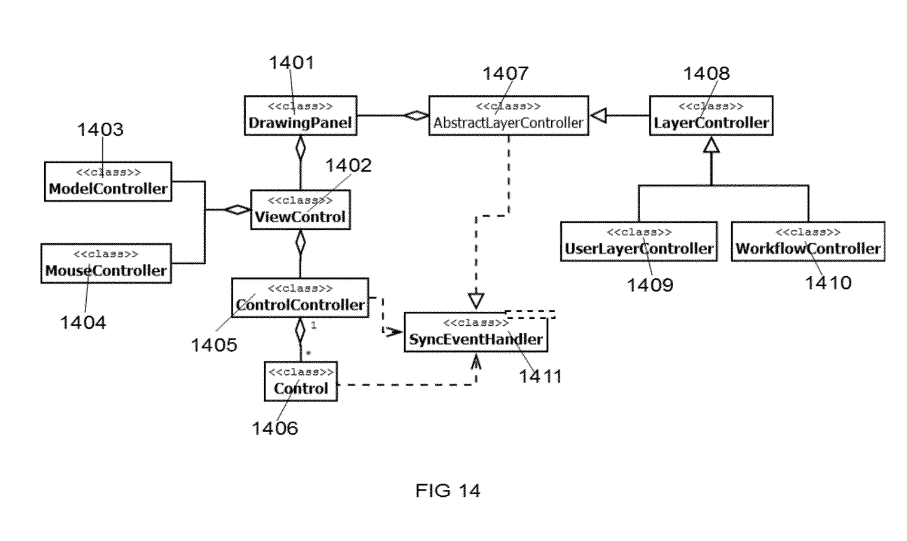

The top-right portion of FIG. 14 is the data processing portion of dynamic control. The data for DCs are loaded and processed by the layer controller (1407). Depending on the running platforms (mobile, web, desktop), the procedures of loading and processing DCs may be different. An abstract layer controller class has been extracted (1407). AbstractLayerController (1407) implements the general properties of the procedures and LayerController (1408) implements the concrete parts that are dedicated to the particular platform. UserLayerController (1409) extends the layer controller to handle the tasks related to the user layers. And WorkflowController (1410) extends the layer controller to handle the tasks related to the workflows.

The synchronization between the view and the processor is handled by SyncEventHandler (1411). When the layer controller is created, an instance of SyncEventHandler is planted into the ViewControl instance. When LayerController finishes the processing, the refresh method of SyncEventHandler is called to force the view to refresh for the newly loaded data.

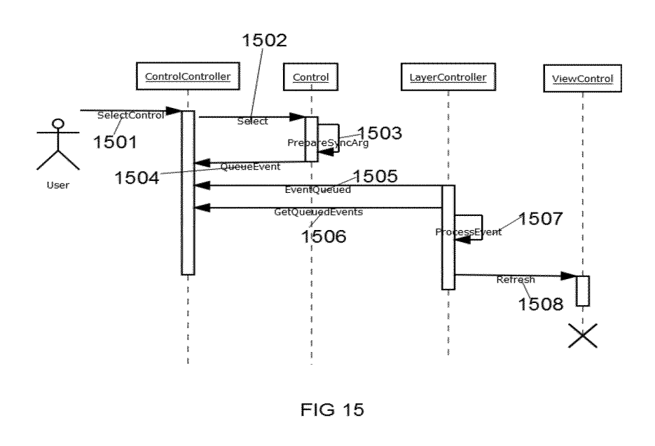

FIG. 15 shows the simplified sequential diagram to illustrate how DC engine processes the dynamic controls. User issues the command of selecting control (1501) by clicking or tapping the screen. The request will be send to ControlController. ControlController will find the control based on the coordinates and calls the select method (1502) to that control. Then, inside the control, the implementation of select method will prepare the parameters for the event (1503) based on the state of the control. After the parameter has been created, the control queues the event to ControlController (1504). Now, LayerController kicks in. It first finds out whether or not there is any events queued on ControlController by calling the EventQueued method (1505). Then, it gets the queued events (1506) and processes those events (1507). After finishing processing, ControlController calls the refresh method (1508) on ViewControl to refresh the display.

What is claimed is:

1. The NCDC role model, which defines and develops the different roles involved in the enterprise systems, comprises the developers, the business analysts and the end users. The business analyst is the role to develop the enterprise solutions

2. The NCDC workflow model, which defines and develops the concepts applied to the role model in claim 1, comprises the workflow, the stages in the workflow and the dynamic controls for the stages.

3. The NCDC programming model, which is the programming framework defined and developed for the workflow model in claim 2, comprises the workflow container, the workflow, the stage, the data container and the dynamic control.

4. The dynamic control SDK (Software Development Kit), which is developed for the developers to write the custom dynamic controls, comprises the interface definitions, the dynamic control implementations, and the development of command and property dialog box

5. The DC engine, which is the runtime software processing engine developed to process the framework in claim 2 at runtime, comprises the software engine implementations on mobile, desktop and web browser platforms.
